(19) United States
(12) Patent Application Publication
(10) Pub. No.: US 2004/0153305 A1
(43) Pub. Date: Aug. 5, 2004

(54) Method and system for automated matching of text based electronic messages

(76) Inventors: Mircea Gabriel Enescu, Vancouver (CA); Emilia Enescu, Vancouver (CA)

Correspondence Address: Mircea G. Enescu, Apt. 903, 1434 Burnaby St., Vancouver, BC, V6G1W8, CA

(21) Appl. No.: 10/356,805

(22) Filed: Feb. 3, 2003

(51) Int. Cl. G06F 17/28

(52) U.S. Cl. 704/2

(57) ABSTRACT

The present invention relates to a system and a method allowing users to send text messages to a processing station in electronic form and get back lists of other messages semantically matching theirs. On the logical side it consists of an artificial language (meant to be read or written, not spoken), its translations to various natural languages, a message structure and a message comparison mechanism. On the physical side it includes processing stations, communication channels and web interfaces. The artificial language consists of a domain specific vocabulary constructed according to well-defined rules and a grammar that enforces a tree-like structure on text. Automatic translation between the internal representation of the artificial language and various natural languages is done through online dictionaries. Messages essentially consist of free text fields containing only words picked up from the dictionaries. Semantic comparison of text fields is done through subtree matching.

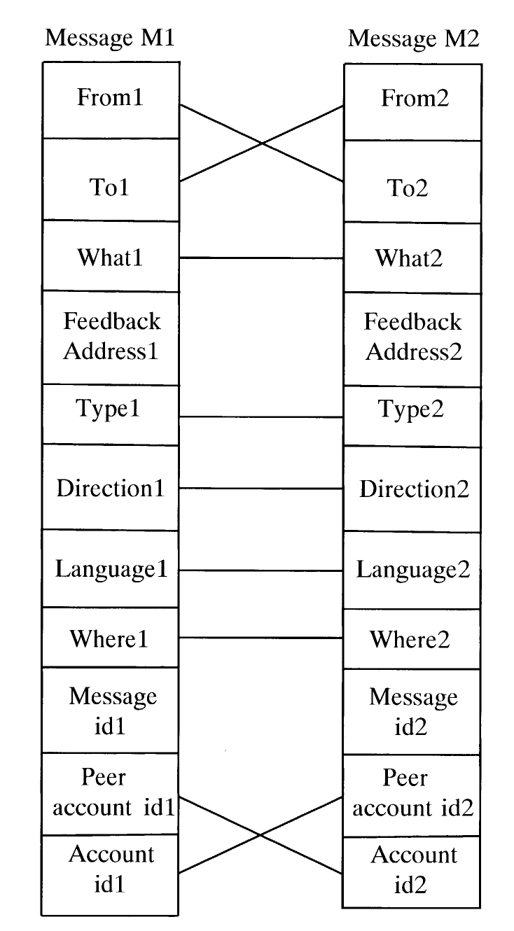

### FIELD OF THE INVENTION

The present invention relates to creating an artificial language, a message structure and a method and system for semantic matching of text-based messages. It could be used as a general mechanism for dispatching messages, for automated matching of electronic classified ads, for email-like communication with built-in capabilities of broadcasting and semantic filtering of unsolicited messages and for a news service with dynamically created channels. In systems where the artificial language has been translated to several natural languages senders can post messages in a natural language and receivers can read them in a different one.

### BACKGROUND OF THE INVENTION

Let's consider a set of users and a communication medium they share (ex: the Internet, a company's intranet etc.). Provided the number of such users is large enough one or both of the following two situations can occur: (a) users might not be all interested in the same things at the same time; (b) there might be no easy way of dynamically grouping those users based on criteria that are either complex or change rapidly over time.

Let's designate those users who send messages as Writers and those who receive them as Readers. Of course their roles can and do change in time, Readers becoming Writers and viceversa (Writers and Readers could be humans or generic data producers/consumers). We try to determine here how could a Writer deliver a text message only to interested Readers. We identify two classes of solutions to the above problem.

Writers Pushing Messages to Readers' Boxes

Delivering the message directly to users' message boxes is only practical in situations where there are not too many Readers. An implementation of this idea is in the use of email lists when the Writer chooses the Readers who are perhaps interested in a certain message. Broadcasting a message to all Readers is another solution although it could flood Readers' boxes with countless messages. Still, Readers can set up filters which would only allow messages based on keywords found in their contents but the matches are not guaranteed to be meaningful. With the added disadvantage of not addressing the natural language barrier problem this class of solutions is not general enough.

Readers Pulling Messages From a Central Location

Writers can alternatively send (push) messages to a central station from where interested users (Readers) could pick them. We call the station central because it is shared between all Writers and Readers.

One solution that falls into this category is the use of ontologies which offer-users (both Writers and Readers) a few areas of interest to choose from at the top level and takes the users deeper into hierarchies of goods and services (or whatever knowledge area the ontology models) through successive refinements of the choices (Ex: Automotive —>Car —>Sedan —>Make —>Year etc.). With this approach Writers basically send their messages to a corresponding virtual pool of messages identified by a category/subcategory while Readers would browse through all messages in the message pool they are interested in. Ex: one such pool could be a ‘meetings/executive meetings/Houston branch’ on a company's Intranet.

Another solution (suggested in U.S. Pat. No. 5,283,731 issued to Lalonde et al.) is the creation of two databases: one for ‘ads’ and another for ‘want ads’ consisting of object definitions and their predefined properties. The databases are compared against each other and the messages' authors are notified in the event of a match.

In the U.S. Pat. No. 6,253,188 issued to Witek at al. a Reader has to interactively browse through a message database by specifying category/subcategory and search criteria while a Writer has to specify text recognition information specific to the electronic newspaper where the message is posted.

Another solution that is relatively widely used is based on user profiles. These identify what could be of interest to a certain Reader. While user profiles are a powerful technique there is no standard to precisely define such profiles.

All of the above approaches suffer from several shortcomings. First and foremost they lack flexibility. They make it really hard to specify anything that is not mainstream or is too specific. What if a user wants a red car with a green roof that once belonged to a Hollywood star? Furthermore there is no way of specifying who are the Writers and Readers and there is no provision for the exchange of information between users of different natural languages.

### SUMMARY OF THE INVENTION

It is an object of the present invention to create an artificial language suitable for clear structuring of text and fast semantic comparison, and to provide rules for translating that artificial language to natural languages.

Additionally, it is an object of this invention to create a message structure suitable for semantic message matching.

Further, it is an object of the present invention to create a method and system whereby message senders (Writers) will have their text messages delivered precisely to receiving parties (Readers) who expressed an interest in those messages and for Readers to receive exactly the messages they expressed an interest in.

Yet additionally, it is an object of this invention to provide a mechanism for Writers to send messages in a natural language of their choice and for Readers to read those messages in a different language if they so choose.

All entities that are deemed important for the description of the invention are capitalized in the text below. Unless otherwise specified ‘free text in a natural language’ means text that follows the artificial language's grammar and uses only words picked up from the translation of the artificial language to that natural language. The invention described herein relates to a method and a system whereby users send Messages to a Processing Station and get back lists of other Messages semantically matching theirs. It consists on the logical side of an artificial language, translations of that artificial language to various natural languages, a message structure and a mechanism for semantic message comparison. On the physical side it consists of one or more Processing Stations and web interfaces allowing users to directly interact with the system from their terminals (ordinary PCs, laptops etc.). Every interaction of a user with the system is always done in two steps:

Sending a Message. During this stage the Message's author acts as a Writer.

Browsing through the matching Messages on the Match List that the system generates. During this stage Messages' authors act as Readers.

Logical View of the System

A Message has a well-defined structure and consists of several fields fully specified in DETAILED DESCRIPTION. For now we only mention four text fields (see drawing): From, To, What and Feedback Address. From describes the Message's author (the Writer), To describes the users to whom the Message is addressed (the Readers), What describes what the Message is about (the Content) and Feedback Address specifies how the Writer could be contacted for further talks. It should be noted that what is considered a Writer in a Message will be considered Reader in a matching Message and viceversa.

Text in the first three fields above has to be entered using an artificial language. This language has a very simple Grammar (formally presented in the DETAILED DESCRIPTION section), rules for capturing concepts to make up Vocabularies, a method for encoding those concepts to form the internal representation of the Vocabulary, rules for creating translation Dictionaries and conventions for writing text.

The language's Grammar is used both internally by the system and externally by the users and imposes a tree-like structure on text in any of the From, To and What fields.

A Vocabulary can model a certain knowledge domain (for example classified ads, or the set of objects and actions in the dialog between an operator and a group of intelligent machines, etc.) and consists of several classes of concepts: objects (both concrete and abstract), actions, relations, attributes, measures and units of measurement specific to the domain.

To fit the present invention's requirements the concepts need to be chosen such that they form single inheritance hierarchies (trees) for each of the above Classes of Concepts (objects—concrete or abstract, actions, relations, attributes, measures, units of measurement). There are some other requirements like eliminating synonyms, all forms of nouns except nominative singular etc. If there is a need to specify geographical locations with greater accuracy the choice of places used to fill in the Where field (see Message structure further below) can include city quarters and streets in addition to cities.

Once the domain concepts have been chosen, the next step is to represent those concepts in a form suitable for internal use by the system (that is, internal words). This internal representation will reflect the Concept Classes hierarchies and ensure they are easy to recognize and compare. Since the artificial language is not meant to be spoken, any combination of characters (vowels, consonants) is valid. With this step the building of the artificial language is complete.

The next step is to create Dictionaries for translation between the internal form and various natural languages (English, French, German, Spanish etc.). Because the Grammar is the same all that needs to be done is a word-for-word translation. Yet caution should be exercised here as a word might have multiple senses. For example the English word ‘book’ should be explained like ‘book[volume]’ or ‘book[V;reserve]’. When entering data into or extracting data from the system a human user will see text translated to the user's natural language. The system will report a parsing error if a user enters other words than the ones defined in the Dictionary. Through the use of Dictionaries a Message in its internal form can be represented externally in any natural language for which a Dictionary exists. It is possible to insert a message in a natural language and later modify it using another one. Actually the system makes it possible for users of various natural languages to freely exchange Messages albeit based on the rather ‘dry’ Grammar. If the intended audience of the system could use different units of measurement for the same measure (like meters, miles, feet) a translation table has to be written for use by the system when translating text to and from internal form.

Besides the Grammar rules users of the system need to follow a few conventions that will be explained in the DETAILED DESCRIPTION section.

The first word in the tree structure of a text field carries the most semantic content in text comparison operations and will be called Root Word. Subsequent words will qualify this Root Word and can be qualified themselves to any depth. Leaves in the tree structure carry the least semantic content.

Text fields are semantically compared against one another using subtree-matching starting at the Root Word, going through every branch and ending at the leaves.

Suppose Writer1 sends Message1 containing From1, To1 and What1 while Writer2 sends Message2 containing From2, To2 and What2. If From1 is a match for To2 and To1 is a match for From2 and What1 is a match for What2 then the Station will insert Message1 on Message2's Match List. If at the same time From2 is a match for To1 and To2 is a match for From1 and What2 is a match for What1 then the Station will insert Message2 on Message1's Match List. It should be noted here that matching viewed as a binary relation from the set of all pieces of text to the same set is not reflexive. If From 1 is a match for To2 it is not necessary true that To2 is a match for From 1. In the end both Writer1 and Writer2 can browse through their respective Match Lists thus getting to be Readers of each other's Message.

The method presented in this invention relies on people's ability to express concisely and precisely what they want. Because of this the system does not need knowledge bases. People do have such knowledge bases stemming from their culture and experience. The principle we used is that if concepts in the Vocabulary are semantically distant then different ideas must be expressed through different pieces of text. It follows that if two pieces of text are identical they must be external representations of the same ideas.

Physical View of the System

The system is fully scalable and consists of one or more Processing Stations that communicate with each other over encrypted TCP/IP channels, and web interfaces through which users can connect to the system. A Processing Station resides on a server box and consists of an instance of the support programs, data files and communication port. The pair (server, port) is unique throughout the system. The same server can host several Processing Stations (listening to different ports). In order to use the system users have to open an account on at least one of the Processing Stations. An account is uniquely identified in the system through the triplet (server, port, account). This triplet will be referred to as Account id (see drawing) and is stamped by the system on every Message as its Writer creates it. A Message can only be generated on the Station where the Message's Writer has an account. A Message's life is determined by the definition it gets when it is sent to the Station. If the Message is sent as a Posting it will be stored to permanent storage and will be uploaded to volatile memory on the Station until the day it expires or is deleted by its Writer. If the Message is sent as a Query it will be broadcast to all Stations, compared against all Postings previously uploaded to volatile memory, then discarded. It should be noted that there is no difference between the formats of Postings and Queries. Exactly the same Message can be sent to the Station as Posting, Query or both. Actually one feature of the system is to compare Postings against each other by having them resent to the system as Queries without human intervention. Users enter text by selecting words from the online Dictionary on a web based Message form or directly typing them in the form from the keyboard. If the user is a generic data source though, the Message has to be generated outside the system and entered through HTTP.

When a Query is compared to Postings the system creates Match Lists for the Query and each of the Postings. From the Station where they were generated these Match Lists are forwarded to the Stations where the Messages' Writers keep their accounts and stored to permanent storage. As Match Lists are inserted into the database, notifications are emailed to Messages' Writers. Each such notification will contain the Message's Id number, the Matching Message's Id number and the Matching Message's Feedback Address. Users, too, can browse through all Matching Messages using a web interface. Notification emails are electronically signed to prevent outsiders from masquerading as the service provider.

Although the system allows access to any user through its public web interface there might be users who find it difficult to write text following the artificial language's Grammar described in the present invention. To help those, a separate service could be offered by VARs through special stations, that provides translation between natural languages and the artificial language in addition to entering data into/extracting data from the system.

### BRIEF DESCRIPTION OF THE DRAWINGS

The drawing shows the Message structure and how Message fields are matched.

### DETAILED DESCRIPTION

In a preferred embodiment the artificial language mentioned above is used together with the Message structure and Message comparison mechanism to provide a solution to the following problems: (a) how could a Writer send some content precisely to Readers who expressed an interest in that content and who agreed to receive messages from that Writer; (b) how could messages be automatically translated between various natural languages. The artificial language's Grammar

The artificial language used to fill in Message's text fields has a very simple Grammar described below in BNF notation:

<text> ::= <word_equiv>
<sum> ::= <word_equiv> AND <word_equiv> | <sum> AND <word_equiv>
<word_equiv> ::= <noun_ending_seq> | <verb_ending_seq> | <noun_ending_seq> <final_qual> |
<noun_ending_seq> NAMEPROPER | <verb_ending_seq> <final_qual>
<noun_ending_seq> ::= <noun_equiv> | <noun_ending_seq> <noun_equiv> |
<noun_ending_seq> RELATION NOUN | <verb_ending_seq> <noun_equiv> |
<verb_ending_seq> RELATION <noun_equiv>
<verb_ending_seq> ::= VERB | <verb_ending_seq> RELATION VERB | <noun_ending_seq>
VERB | <noun_ending_seq> RELATION VERB
<final_qual> ::= ATTRIBUTE | LP <sum> RP | <numeric_qual> | QUOTED_TEXT
<noun_equiv> ::= NOUN | PRONOUN
<numeric_qual> ::= MEASURE NUMBER UNIT | MEASURE NUM_REL NUMBER UNIT |

MEASURE NUM_REL NUMBER NUMBER UNIT

The terminal symbols above represent:

NOUN—a common noun (a concrete or abstract object)

VERB—an action

ATTRIBUTE—an adverb, an adjective or a special word denoting the tense of a verb, the plural of a noun etc. The special words represented this way begin with the prefix ‘attr_’ and will follow the word they qualify (postfix notation). Ex: ‘person work[V] attr_past time’=person who worked.

NUM_REL_numeric relation (greater_than etc.). Ex: ‘temperature greater_than 32 degree_F’

LP, RP—left and right parentheses

QUOTED_TEXT—arbitrary text (not necessarily part of the Dictionary—see further below) enclosed in single quotes. Text is internally stored in UTF7 format and can be written in a natural language different than the basic natural language in which the Message is submitted.

AND—the conjunction ‘and’

RELATION—a preposition or a conjunction. To be easily found in the Dictionaries a RELATION will start with the prefix ‘rel_’ (ex: rel_cause, rel_condition, rel_purpose). A RELATION will be represented in infix notation (between the two words it connects) unlike an ATTRIBUTE, which is represented in postfix notation. Ex: ‘sleep rel_position bed’=to sleep in bed.

NAMEPROPER—a proper noun (like Paris[France]); such names are used to specify geographical entities like countries, provinces and cities.

PRONOUN—one of the pronouns ‘I’, ‘you’, or ‘we’. ‘I’ represents the Writer, ‘you’ represents the Reader and ‘we’ represents both the Writer and the Reader (together).

MEASURE, NUMBER, UNIT—straightforward

The Grammar enforces a tree structure on a text field. Nodes represent words or numbers (both of which are the values associated with the nodes) while edges have no associated values and represent links between words. Thus nodes have semantic values while edges don't. The greatest amount of semantic content is associated with the root node. Semantic relevance decreases from the root to the leaves. Branches starting at the same node represent different qualifiers of that node, having equal relevance as regards that node. Parentheses can be used to group several qualifiers together. Ex: ‘car (fast and cheap)’=a car that is both fast and cheap. QUOTED_TEXT can be used to insert words that are not defined in the Dictionary or chunks of text in another natural language than the basic one used to build the text. Thus it is possible to tunnel text written in natural language L2 in a Message written in the basic natural language L1. The range of potentially matching Messages narrows down with each word that is being added to the text. Measures, units and numbers are used to express and compare quantities. The system uses predefined formulae to transform all units of measurement into canonical internal units (and back). The only exceptions are currencies (USD, EUR, CAD etc.), which are translated based on current rates. Proper names can only follow a common name that specifies a context for the proper name. Without a common name prefixing it a proper name like Sydney could be the name of a restaurant, a person, a city, a street etc. This is why it needs to appear in a context like ‘restaurant Sydney’ or ‘city Sydney[Australia]’ etc.

The Grammar described herein is used both for the internal and external representations of free text.

Rules for creating a Vocabulary

The Vocabulary can be customized for any specific knowledge domain. It comprises the following Concept Classes: objects, actions, attributes, relations, measures and units of measurement specific to that domain. It needs to be designed by domain experts.

In the Vocabulary all entities are organized as hierarchies. There would be a separate hierarchy for each of the Concept Classes. Each entity has at most one parent (single inheritance).

Entities are semantically distant so that a user who knows the Vocabulary should have no problem choosing the right concept (word) when building text.

Verbs will have a single form that is infinitive (no subjunctive, vocative etc.). Verb tenses (past, future) are indicated through special attributes (attr_past tense, attr_future_tense).,

Nouns will have a single form that is nominative singular. Even if some natural languages do not support the plural this concept can be introduced and represented as an attribute (ex: attr_plural). Noun's articles are eliminated so that a text can refer to either any instance of an object or a specific one depending on the context. The idea here is that a noun starts as a generic one but as it gets qualified through other words it could end up being unique if it is singled out through enough qualifiers.

All degrees of comparison of adjectives are eliminated just like adverbs that modify adjectives (very, too, etc.).

From a pair of verbs having opposite senses (antonyms) only one will be kept. For example if ‘sell’ exists, ‘buy’ won't be inserted into the Vocabulary.

Three numeric relation indicators (NUM_REL) will be introduced: greater_than, less_than and between-the-values.

Whenever possible the noun denoting a measure will be inserted in lieu of a corresponding adjective. Thus it will be easier to compare a ‘bed length greater_than 9 feet’ meaning a 9 ft. long bed than ‘bed long’.

No idiomatic expression should be introduced.

Relations (prepositions, conjunctions) should be introduced as needed: cause, condition, purpose, concession, position, means etc. Direct and indirect object concepts can be added to this category.

A single concept from a family of related concepts should be introduced. Thus from (strong, strength, to_strengthen) only strong could be introduced. The other elements can be referred to through special words like ‘quality_of being’ (ex: strength=quality_of being strong). A Vocabulary designer should have some grammatical knowledge or engage the services of a specialist to assist with these issues. For short, there are actions (to_hit), action names (hitting), action results (a hit), states caused by actions (hit by the ball); there are qualities (beautiful), quality names (beauty), actions getting objects to have a quality (beautify). From each such family of words a single one should be chosen. Related words can be generated through special words as shown above.

If two concepts are not too distant semantically (e.g. synonyms) they should be merged into a single concept. This can prevent misunderstanding (a comparison mismatch where there should have been a match). For example a Vocabulary shouldn't include both ‘sad’ and ‘unhappy’.

Concepts do not necessarily map exactly to words in a particular natural language. There might be a word with two different senses (homonyms) in which case two concepts should be introduced to capture both meanings of that word. For example ‘bear’ as a noun versus the verb ‘bear’.

It should be noted that there are differences between the cultures and hence vocabularies in different countries. This is only an issue if the Vocabulary is designed for international use.

Internal Representation of Vocabulary Concepts

Vocabulary concepts identified in the previous step need to have an internal representation which will be used for storing and comparing text fields in Messages. The artificial language (that is the Grammar plus the internal representation of a Vocabulary) presented herein is meant to provide a way to refer to an object or action with enough accuracy while keeping a high speed of comparison. While several encodings can be designed the one implemented in this invention uses only ASCII characters and makes a parent a substring of its child. Thus if a classic taxonomy is being used and the internal word for animal is ‘fd’, a tiger could be ‘fdwmcht’. Intermediate nodes (vertebrate, carnivore, feline etc.) haven't been represented above. Note that ‘fd’ is a substring of ‘fdwmcht’ so a comparison routine will quickly figure out that a tiger is a sort of animal. Differing concepts will be encoded differently even if in a particular natural language the same word is used for both. Thus school as a building will have a different representation than school as an institution. Translating the artificial language to natural languages

Since the Grammar is the same, translating the artificial language to a natural language amounts to representing the Vocabulary concepts in that natural language. If a concept maps to a word which has multiple senses (homonyms) in a certain natural language the word will need a hint to which sense is being used (ex: bear[animal]). If two very similar concepts have been merged into a single one the representations could include both words. For example ‘wound,injury’. If there is an ambiguity about a word's parent in the word hierarchy a short hint added to the word should clarify it. Relations could be represented as special words by prefixing them with ‘rel_’ in order to group them in alphabetic order in the online Dictionary. For example the direct object relation could be represented as ‘rel_direct object’. Special words can be used to represent some forms of nouns or verbs as well. For example ‘meet (rel_direct_object president company and attr_past tense)’ would mean ‘met company's president’. Internal and external representations of the Vocabulary are connected through Dictionaries written in Unicode.

Conventions for Using the Artificial Language

With a few exceptions (AND, LP, RP, numbers) text entered by users in each field needs to contain only words picked up from the Dictionary corresponding to the natural language the user chose to use and which is supported by the Station. If there is no Dictionary entry for an entity then the next more general entity should be used. If the relationship between two words is one of the types ‘HAS_A’, ‘IS_PART_OF’, ‘BELONGS_TO’ or ‘WHICH’ then the two words should be concatenated without specifying the relationship between them. Examples: ‘button shirt person old’ would represent a button from an old person's shirt; ‘person (shirt button and old)’ represents an old person who has a shirt with button(s).

How Text Fields are Compared

In the context of the What field (see Message structure below) the pronoun ‘I’ represents the Writer, ‘you’ represents the Reader, ‘we’ represents both the Writer and the Reader and the following hold true: ‘I’ is a match for ‘you’; ‘you’ is a match for ‘I’; ‘we’ is a match for ‘we’; ‘we’ is a match for ‘I’; ‘we’ is a match for ‘you’.

Suppose T1 and T2 are the tree representations of two texts formatted as described above. Let's define the T tree's structure as being the T tree without the values associated to its nodes. Then T1 is a match for T2 if and only if all of the following conditions apply:

T2's structure is a subtree of T-'s structure, starting at root or is equal to T1's structure

For every node in T2 its node value is either equal to or a substring of the corresponding node value in T1.

For every three adjacent nodes in T2 for which the associated values are of the types NUM_REL NUMBER UNIT the relationship ‘NUM_REL NUMBER UNIT’ in T1 is stricter than the relationship for the corresponding node values in T2. (Ex: ‘less_than 32 degree_F’ versus ‘less_than 5 degree_C’).

For every node in T2 for which the associated value is the pronoun ‘I’ the corresponding node value in T1 is either ‘you’ or ‘we’.

For every node in T2 for which the associated value is the pronoun ‘you’ the corresponding node value in T1 is either ‘I’ or ‘we’.

For every node in T2 for which the associated value is the pronoun ‘we’ the corresponding node value in T1 is ‘we’.

Message Structure

Each Message follows the paradigm: a Writer transmits a Reader some Content and expects to be contacted at Feedback Address. A well formed Message has a fixed format and consists of the fields (see drawing):

From—free text that describes the Message's author (the Writer).

To—free text that describes for whom the Message is intended (the Reader or Readers).

What—free text that describes what the Message is about (its Content).

Feedback Address—free text that specifies how a Message Writer could be contacted by matching Messages' Writers, or how a matching Message can satisfy what the base Message asks for: email address, fax number, street address, web site etc.

Type—choice that specifies how the Message should be interpreted. Possible values are: (a) want; (b) announce; (c) think; (d) feel. In a Message of Type (a) the Writer would like any of the following: that an object or a piece of information be offered or a service be done without the Writer being actively involved (hoping Reader or perhaps an agent working on Reader's behalf would do the job); to actively arrange for an object or a piece of information to be offered or a service to be done perhaps through an agent or acting alone; to establish a relationship or collaborate with someone. In a Message of type (b) the Writer: makes known something he/she claims to be a fact or listens to announcements stating the fact that is described in Content. In a Message of type (c) the Writer either expresses what he/she thinks (as opposed to type (b) where the Writer presents a fact) or listens to other Messages where people express thoughts described in Content. In a Message of type (d) the Writer describes what he/she feels (which is neither a fact nor a well founded thought) or listens to other people who feel the way described in Content.

Direction—a choice of three possible values: Inbound, Outbound or Bi-directional. It should be mentioned now (see details further below) that Content's Root Word is a verb describing the essential action of the Message (ex: ‘sell’ or ‘hire’). Thus Content itself can be deemed an action. The Direction identifies either the degree of control that Writer and Reader have over the Content (for Messages of Type=‘want’) or the positions that Writer and Reader have with regards to the Root Word (which is a verb) in Content (for Messages of Type=‘announce’, ‘think’ or ‘feel’). The Direction of the Message needs to be set to Outbound in any of the following cases: Writer wants Content to happen and either himself/herself or an agent working on Writer's behalf has full control over Content. This means that Writer can determine Content to happen (Type (a)); Writer announces what is described in Content (Type (b)); Writer affirms that he/she thinks what is described in Content (Type (c)); Writer affirms that he/she feels what is described in Content (Type (d)). The Direction of the Message needs to be set to Inbound in any of the following cases: Writer wants Content to happen but has no control over it. This means that Writer wants others to determine Content to happen (Type (a)); Writer waits for (listens to) the announcement described in Content (Type (b)); Writer looks for somebody who affirms that he/she thinks what is described in Content (Type (c)); Writer looks for somebody who affirms that he/she feels what is described in Content (Type (d)). The Direction of the Message needs to be set to Bi-directional if Writer wants Content to happen but control over it is split between Writer and Reader (or agents working on their behalf). This means that Writer can determine Content to happen to a certain extent but needs Reader's contribution for the rest. A few examples should clarify this last case. Suppose a Message has Direction=‘Bi-directional’, Type=‘want’, From =‘man hair black’, To=‘woman eye green’, What=‘make_friends (I attr_subject and you attr_subject)’. This Message would be a perfect match for a similar one where From and To fields are reversed. Both of them want a black haired man to make friends with a green-eyed woman (or viceversa, which is essentially the same thing). It should be noted that control is shared: neither the man nor the woman can make friends if the other doesn't want to. Suppose another Message with Direction=‘Bi-directional’, Type=‘want’, From =‘electrician’, To=‘agent’, What=‘fix (I attr_subject and plumber (strong and attr_subject) and condo attr_direct_object)’. This would mean that an electrician wants to let an agent know the wishes to fix a condo working together with a strong plumber. Supposedly the agent would find the strong plumber needed for the job. Here again control is shared. The electrician cannot work alone and neither can the plumber for that matter.

Language—specifies the natural language that Writer wishes to use for further talks with Writers of matching Messages. One of the choices is Any.

Where—limits the Message geographically to a certain country, province or city.

Message id—is a user assigned Message identifier supposedly unique throughout the Messages sent by the same Writer. It is used as a reference in further talks between Message Writers.

Account id—is a triplet (server name or IP address, port number, account number) that uniquely identifies an account on a system. These fields cannot be set by the Writer when creating a Message. Rather, they are generated by the system.

Peer account id—is a triplet (server name or IP address, port number, account number) that a Writer can fill in to specify the unique Reader the Message is addressed to.

How Messages are Compared

Suppose M1 and M2 are two Messages and all of M1's fields have 1 for suffix while all of M2's fields have 2 for suffix (see drawing). Message M1 is a match for M2 if and only if all the following hold true:

From1 is a match for To2.

To1 is a match for From2.

What1 is a match for What2.

Type1=Type2.

Direction1=‘Inbound’ and Direction2=‘Outbound’, or Direction1=‘Outbound’ and Direction2=‘Inbound’, or Direction1 anything and Direction2=‘Bi-directional’.

Language2=‘Any’ or Language1=Language2.

Where2 is blank or Where 1 is geographically located inside Where2.

Peer account id2 is blank or Account id1 is identical to Peer account id2.

Peer account id1 is blank or Account id2 is identical to Peer account id1.

If Text1 and Text2 are two text values taken by the fields F1 of type From and F2 of type To then F1 is a match for F2 if and only if Text2 is blank or Text1 is a match for Text2. Same conditions hold if F1 is of type To and F2 is of type From or if both F1 and F2 are of type What.

Conventions for Creating Messages

The pronouns ‘I’, ‘you’ and ‘we’ can only be used in the What field. The From and To fields can be left blank in cases where Writer and Reader are not deemed important. The What field can be left blank, too. A blank Content combined with an Inbound Direction will allow the Message's Writer to receive any Content because any text is a match for a blank text. If the From field is not blank it should be the description of Writer as viewed by an external observer. As such, its Root Word needs to be an object. Ex: ‘person love[V] dog’ would represent a person who loves dogs; ‘company small’ would represent a small company. If the root object is qualified by a verb the verb needs to come second. If the To field is not blank it should be the description of Reader as viewed by an external observer. Ex: To=‘person hate[V] dog’ would mean that the Message is addressed to a person who hates dogs. The first word of the To field needs to be an object just like in the From field above. If the What field is not blank it should be represented in prefix notation (the Root Word should be a verb) and should describe what the Message is about (Ex: ‘fix[V] car attr_direct object’). As was mentioned before, this root verb indicates the essential action of the Message. There might be other verbs describing the action in more detail but the root verb is the root of the word tree in the What field.

Physical View of the System

The system consists of Processing Stations, secure TCP/IP connections between them and web interfaces. Each user of the system has an account on a Station. The Station where a user has an account is that user's Home station. A user communicates directly only with his/her Home Station. Communication between Stations is transparent to the user. A minimal system has just one Station.

Users access their Home Stations through web interfaces. Each Station supports the following user interface functions:

Insert Posting/Query. The Station receives new Messages (in a natural language) through the filled in forms, parses and translates them to an internal form (artificial language). If the Message is a Posting it gets stored on permanent storage. If it is a Query it is broadcast to all Stations (a single one for a minimal system) where it is compared against all Postings. Message forms are encoded as follows: ISO-8859-1 for Western European languages; ISO-8859-2 or UTF-8 for other European languages; UTF-8 for non-European languages. After comparison Match Lists are created for both Queries and Postings and stored to permanent storage on users' Home Stations for future inspection. If a Match List is generated for a certain Message the Home Station will email the Message's Writer a digest of the Match List consisting of all Message ids and Feedback Addresses from the matching Messages.

View Posting. This function displays previously inserted Postings (in any language that the Station supports).

Modify a previously inserted Posting.

Delete an older Posting.

View Match Lists for both Postings and Queries in any natural language that the Station supports.

Delete Match Lists for both Postings and Queries.

How to Use the System

The system presented herein has no knowledge of the domain being modelled other than the domain's hierarchy of entities and formulae used in translating measurement units between internal and external forms. It does not aim at providing some sort of semantic network. It is merely a vehicle for people to quickly find new contacts or to exchange Messages with other people who are more or less known to them. There are two basic ways of using the system,

Focussing more on Content and less on Writer, Reader and Peer account id. This is meant to make a first contact with unknown parties interested in similar Content. Such is the situation when someone wants to contact others through classified ads. But there are other situations where this solution might prove its use like asking some question on a company's intranet. For example an Outbound Message of Type=‘want’ with blank From and To fields but with What=‘sell[V] car attr_direct object’ is meant to sell a car to anybody who doesn't care who the seller is. It is still possible to specify who the seller is (ex: ‘auto dealer’) and/or who the target is (ex: ‘person’). This last example means that a dealer wants to sell a car only to a person (not a company). If Direction=‘Bi-directional’, From =‘man (hair black and height 6 feet)’, To=‘woman age less_than 25 years’ and What=‘make_friends (I attr_subject and you attr_subject)’ then the Message says that a black haired 6 ft. tall man wants to make friends with a woman younger than 25.

Focussing less on Content and more on Writer, Reader and Peer account id. This approach can be used in email-type communication with built-in broadcasting and filtering unsolicited Messages capabilities. By specifying combinations of the fields From, To and Peer account id communication can be done in one of the following ways: from a user to another user specified through Peer account id; from a user to a group specified through the To field; from a user to a group specified through the Content that group is interested in (its What field). A broadcast email address is created when a user sends a Posting containing a non-blank value for the From field (the group description) with an Inbound Direction. The What and To fields can be used for filtering. A user becomes part of that email group by sending a similar Posting. Email Messages are sent to the group as Queries with the To field set to the value of the From field in the Postings and Direction=Outbound. A private email is sent as a Query with the Peer account id set to the desired Reader's Account id. A user can post several Messages thus creating virtual email-type boxes for communicating with specific users or with specific groups. An email box will contain the Match List associated with a certain Message. Another application of this invention is a usenet-like news mechanism whereby news channels are dynamically specified through the From field while the field To can be used to accept only news from a certain group. The news channel is initiated when a user first sends a Posting containing a new non-blank From field, a blank What field and an Inbound Direction. Another user subscribes to the channel by sending a similar posting. News are posted by sending Queries with the To field set to the value of the From field in the Postings, a non-blank What field and an Outbound Direction. Let's have a look at some examples. Suppose a group of Internet users more or less known to each other identifies itself by the text ‘person (attr_subject and love[V] tiger attr_direct_object)’. If an Outbound Message of Type=‘announce’ sets the values of the From and To Fields to the above mentioned text and provides a non-blank Content (What field) then this Content will reach all members of the tiger lovers' group who listen (Direction=‘Inbound’, Type=‘announce’, From and To set to the above mentioned text, What=blank) to any announcements. If Where=‘Canada’ then the Message is restricted to the Canadian subgroup of tiger lovers. If Language=‘French’ then Message is further restricted to the French speaking Canadian subgroup.

If the artificial language is translated to several natural languages Messages can be created by a Writer in a natural language and read by a group of Readers in other natural languages. Thus it is possible to semantically compare classified ads sent from various countries. Likewise it is possible to have an email-like or news-like Message written in a natural language and read in a different one.

Human users fill text into the Message web form by selecting words from an online Dictionary that comes with the page, through mouse clicks. Messages from other data sources are created outside the system.

While the system offers a public web interface, it might prove to be a bit too complicated for the average user who tries to send a complicated Message. The artificial language requires a minimum knowledge of grammar and the Message fields Direction and Type could be confusing. Yet, if the Message is simple there should be no problem. For more complicated Messages trained operators could provide this service as part of the main service or as a separate service.

What is claimed is:

1. A system which allows users to send text Messages and get back Match Lists consisting of all the other Messages semantically matching theirs, for any given knowledge domain, comprising:
An artificial language including:
(I) A fixed grammar;
(II) A custom vocabulary (set of concepts) that models said knowledge domain;
Translation dictionaries between natural languages and said artificial language;
One or more processing stations including:
(i) Means for accepting messages from users in various natural languages;
(ii) Means for automatically translating said messages to said artificial language;
(iii) Means for storing, uploading, semantically comparing said messages and generating match lists;
(iv) Means for storing and allowing user access to said match lists for said messages in various natural languages;
(v) Means for communicating with other stations.

2. The system of claim 1 wherein messages are Internet classified ads, and the knowledge domain covers either a single classifieds category or all of them.

3. The system of claim 1 used as an email-like communication mechanism with built-in capabilities for filtering unsolicited messages and broadcasting to groups of users specified through text fields, with automated translation between natural languages, used on the Internet or a company's intranet, wherein the vocabulary covers the needs of the particular group of users it serves.

4. The system of claim 1 used as a news-like mechanism with capabilities for filtering and dynamically creating news channels, with automated translation of news between natural languages, used on the Internet or a company's intranet, wherein the vocabulary covers the needs of the particular group of users it serves.

5. The system of claim 1 used as a general filtering and dispatching mechanism for text-based messages whereby said messages are fed to the system by an external application, and the generated match lists are used by said external application or another one.

6. A method which allows users to send text Messages and get back Match Lists consisting of all the other Messages semantically matching theirs, for any given knowledge domain, comprising the steps:
Providing an artificial language (grammar plus vocabulary that models said knowledge domain);
Providing online translation dictionaries between the artificial language and various natural languages;
Providing one or more processing stations, web interfaces, means for communicating between stations and means for user interaction with the system in one or more natural languages;
Accepting messages having a fixed structure from users, in various natural languages, through said web interfaces, whereby said messages' text fields are filled in by selecting words from said online translation dictionaries;
Translating said messages to an internal format;
Semantically comparing said messages to one another and generating match lists;
Saving said match lists to permanent storage for further browsing by message authors in various natural languages;

7. The method of claim 6 wherein messages are Internet classified ads.

8. The method of claim 6 wherein messages are meant to be used like email with built-in capabilities for filtering unsolicited messages and broadcasting to groups of users specified through text fields, with automated translation between natural languages, on the Internet or a company's intranet, wherein the vocabulary covers the needs of the particular group of users it serves.

9. The method of claim 6 wherein messages are meant to be used like news-messages, with capabilities for filtering and dynamically creating news channels, with automated translation of news between natural languages, used on the Internet or a company's intranet, wherein the vocabulary covers the needs of the particular group of users it serves.

10. The method of claim 6 wherein messages are fed to the system by an external application, through said system's web interface, and the generated match lists are consumed by said external application or another one.
